(19) United States
(12) Patent Application Publication
(10) Pub. No.: US 2015/0185757 A1
(43) Pub. Date: Jul. 2, 2015

(54) MULTIFUNCTION OPERATING DEVICE, PARTICULARLY FOR A VEHICLE COMPONENT

(71) Applicant: Behr-Hella Thermocontrol GmbH, Stuttgart (DE)

(72) Inventor: Markus Jantke, Lippstadt (DE)

(21) Appl. No.: 14/412,280

(22) PCT Filed: Jul. 2, 2013
(86) PCT No.: PCT/EP2013/063925

§ 371 Date: Dec. 31, 2014

(30) Foreign Application Priority Data
Jul. 2, 2012 (DE) 102012211437.8

(51) Int. Cl. G05G 9/047

(52) U.S. Cl. CPC G05G 9/047; G05G 9/04788; G05G 2009/04777; G05G 2009/04781

(57) ABSTRACT

The multifunction operating device (10), which is designed particularly as an input device for monitor-controlled devices such as computers, information or entertainment technology devices, vehicle components or generally for a man-machine interface, is provided with a manually operable operating unit (12), which can be rotated about an axis of rotation (16), depressed along the axis of rotation (16) in a flexible manner, and laterally displaced in a substantially radial direction in respect to the axis of rotation (16). The operating unit (12) has a rotary sensor (19) for detecting the current rotational position and a pressure sensor (20) for detecting a depression movement. The operating device (10) also has a movement sensor unit (22) for detecting the direction of a substantially radial movement of the operating unit (12) during the lateral movement of said unit. The movement sensor unit (22) has a driver element (24), which can be movably guided in a radial plane and to which the operating unit (12) is mechanically coupled and which can be moved along during the movement of the operating unit (12). The movement sensor unit (22) has a tilting element (32), which is connected to the driver element (24) in an articulated manner and which can be tilted when the driver element (24) is moved. The movement sensor unit (22) also has at least one sensor for detecting the tilted position of the tilting element (32) during a lateral movement of the operating unit (12).

The invention relates to a multifunction operating device, particularly as an input device for monitor-controlled devices such as computers, information or entertainment technology devices, vehicle components or generally for a man-machine interface.

So-called rotary controllers have proven to be useful as data input devices, particularly in vehicles, which rotary controllers are multifunction operating devices comprising a manually operable operating unit, i.e. the rotary controller, which is adapted to be rotated about an axis of rotation and to be resiliently depressed along the axis of rotation, as well as to be movable in a substantially radial direction with respect to the axis of rotation by tilting and/or by lateral displacement. All of these operating functions can be performed with one and the same element. As an alternative, systems are also known in which turning and depressing are realized with a first element which further also allows for lateral displacement, while an additional element makes it possible to realize a kind of joystick function, i.e. tilting.

Multifunction operating devices of the above-mentioned kind have generally proven useful. They include a rotary sensor for sensing the actual rotational position of the operating unit, a push sensor for sensing the depression movement of the operating unit, and include a displacement sensor unit for sensing a generally radial movement of the operating unit when the same is tilted and/or displaced laterally. Such multifunction operating devices are described in, for example, WO-A-2005/027168, DE-A-100 59 793, DE-A-100 42 028, DE-A-101 20 691, DE-A-102 41 869 and DE-B-103 42 335, DE-T-601 01 972 and WO-A-2012/085363.

It is an object of the invention to provide a structure for a multifunction operating device of the above-mentioned kind, which is as simple as possible, wherein it is possible in particular to use standard components as far as the rotatability and the depressibility of a rotary controller is concerned.

In order to achieve this object, the invention provides a multifunction operating device, particularly as an input device for monitor-controlled devices such as computers, information or entertainment technology devices, vehicle components or generally for a man-machine interface, wherein the multifunction operating device is provided with
a manually operable operating unit, which can be rotated about an axis of rotation, depressed along the axis of rotation in a resilient manner, and laterally displaced in a substantially radial direction with respect to the axis of rotation,
wherein the operating unit has a rotary sensor for sensing the current rotational position and a push sensor for sensing a depression movement, and
a displacement sensor unit for sensing the direction of a substantially radial movement of the operating unit during the lateral displacement of said unit.

According to the invention, it is provided in this multifunction operating device
that the displacement sensor unit has a driver element which is displaceably guided in a radial plane and to which the operating unit is mechanically coupled and which can be displaced along during the displacement of the operating unit,
that the displacement sensor unit has a tilting element, which is connected to the driver element in an articulated manner and which can be tilted when the driver element is displaced, and
that the displacement sensor unit also has at least one sensor for sensing the tilted position of the tilting element during a lateral displacement of the operating unit.

Firstly, the multifunction operating unit of the present invention uses a generally known conventional rotary controller with the associated functions, i.e. the rotatability and the depressibility of a rotary operating element that is most often designed as a rotary knob or ring or the like. The rotary movement of such rotary operating elements is detected by (optical) decoders, for example, whereas a switch, key, (in particular contactless) sensor or the like responds upon depression. Such a rotary/push controller is now combined with a displacement sensor unit realized separately from the rotary/push controller. In this regard, the operating unit, i.e. the rotary/push controller, is mechanically coupled to a driver element that is displaced along when the operating unit is displaced laterally. Thus, in particular the operating unit, including the sensor system for the rotary and depression positions, is shifted along laterally, causing the driver element to be taken along, whereby the latter is also displaced laterally.

According to the invention, the displacement sensor unit also comprises a tilting element in addition to the driver element, which tilting element has an axis extending at an angle with respect to the radial plane and in particular in parallel with the axis of rotation of the operating unit which is supported to be tiltable. The tilting element is articulated with the driver element, which may be effected by means of a ball joint or a living hinge or the like flexible connection, for example, and is supported on a (ball joint) bearing so that the tilting element may be tilted in space corresponding to the direction of displacement in the radial plane and to the extent of displacement of the operating unit or the driver unit. The displacement sensor unit of the multifunction operating device of the present invention further comprises at least one sensor serving to sense the respective tilted position of the tilting element during a lateral displacement of the operating unit.

The tilting element provided according to the invention is a kind of wobble plate or wobble element tilted in space, namely in a spatial orientation that is characteristic of the direction in which the operating unit has been displaced laterally. The lateral displacement of the operating unit is thus converted into a tilting movement of the tilting element. The necessary transmission between the operating unit and the tilting element is formed basically by the driver element which may, for example, be rigidly coupled to the operating unit and is articulated to the tilting element.

This spatial separation of the displacement sensor unit and the operating unit makes it possible to arrange the displacement sensor unit or the tilting element thereof adjacent the operating unit, for example. Thereby, a comparatively flat overall structure is obtained, since now the displacement sensor unit no longer has to be integrated in the rotary/push controller. In an advantageous embodiment of the invention, the tilting element or at least the tilting axis thereof is positioned outside the axis of rotation of the operating unit and the prolongation of the axis of rotation, and is thus arranged adjacent the operating unit.

The wobbling movement, which the tilting element performs as the operating unit is displaced laterally, is suitably detected by at least two sensor elements of the displacement sensor unit. These two sensor elements are arranged on two axes that extend at an angle of substantially 90° relative to each other. The sensor elements may be designed as proximity sensors and sense, as it were, their distance from the tilting element or to a component of the tilting element or a component of the displacement sensor unit.

Suitably, the displacement sensor unit comprises at least three, preferably four sensor elements arranged at substantially equal angles relative to each other for sensing the distances of the tilting element or at least a component of the tilting element or the displacement sensor unit or at least a component of the displacement sensor unit from the respective sensor elements.

As already mentioned above, the sensor or the or each sensor element is configured as an end switch or as an element functioning in a contactless and/or capacitive, magnetic, resistive or optical manner. Due to the offset sensor arrangement, it is possible to determine the respective tilted position of the tilting element based on the known positions of the sensors that respond when the tilting element is tilted. If, for example, four sensor elements are used that are each offset by 90° relative to each other, it is detected, if only one sensor element responds, that the tilting element is tilted in one of four directions offset by 90° relative to each other and that the operating unit is displaced laterally in one of four directions offset by 90° relative to each other, whereas if two adjacent sensor elements respond, it is also possible to detect lateral displacements of the operating unit at an angle of 45° relative to the above-mentioned directions.

In an advantageous further embodiment of the invention it may be provided that the operating unit comprises an outer first operating element rotatable about the axis of rotation of the operating unit, and that the operating unit comprises an inner second operating element surrounded by the first operating element and adapted to be depressed. In this regard, it is possible that also the first operating element is adapted to be depressed. As an alternative, it is also conceivable that either the first operating element or the second operating element is resiliently depressible, or that both operating elements are jointly resiliently depressible.

The following is a detailed description of the invention with reference to an embodiment and to the drawings. Specifically, the Figures show:

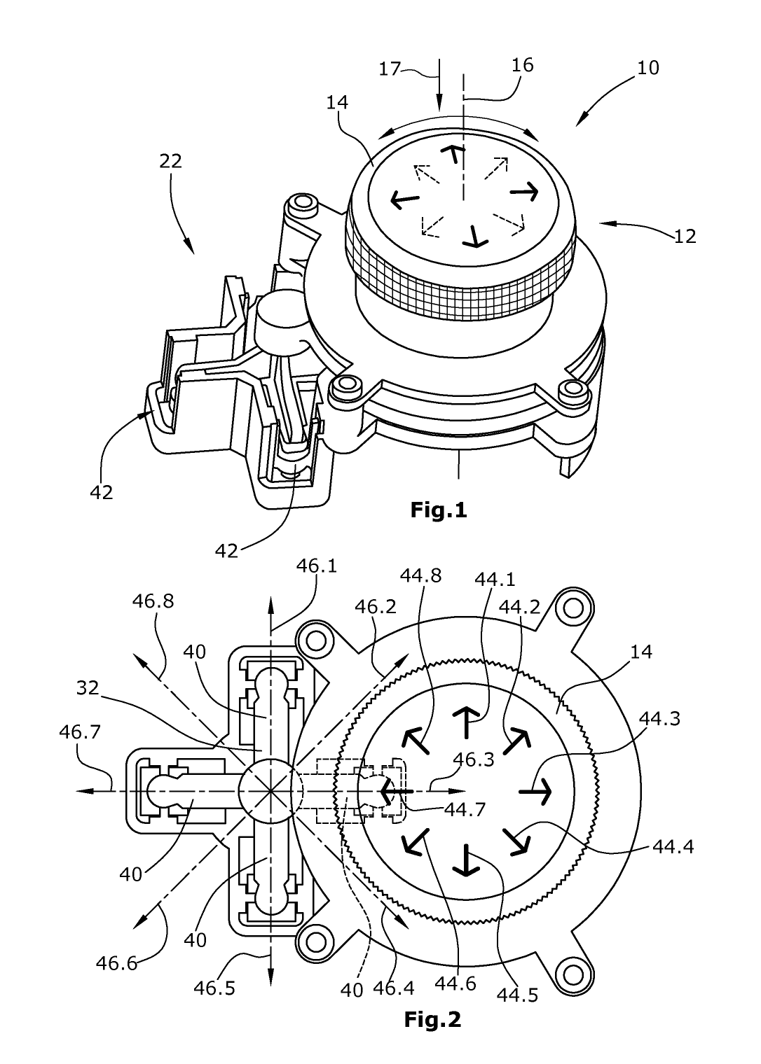

FIG. 1 a perspective illustration of an embodiment of a multifunction operating device according to the invention,

FIG. 2 a top plan view of the operating device of FIG. 1, indicating the conversion of the lateral displacement of the operating unit in the eight directions into a tilting of the tilting element in space in the spatial directions corresponding to the eight displacement directions,

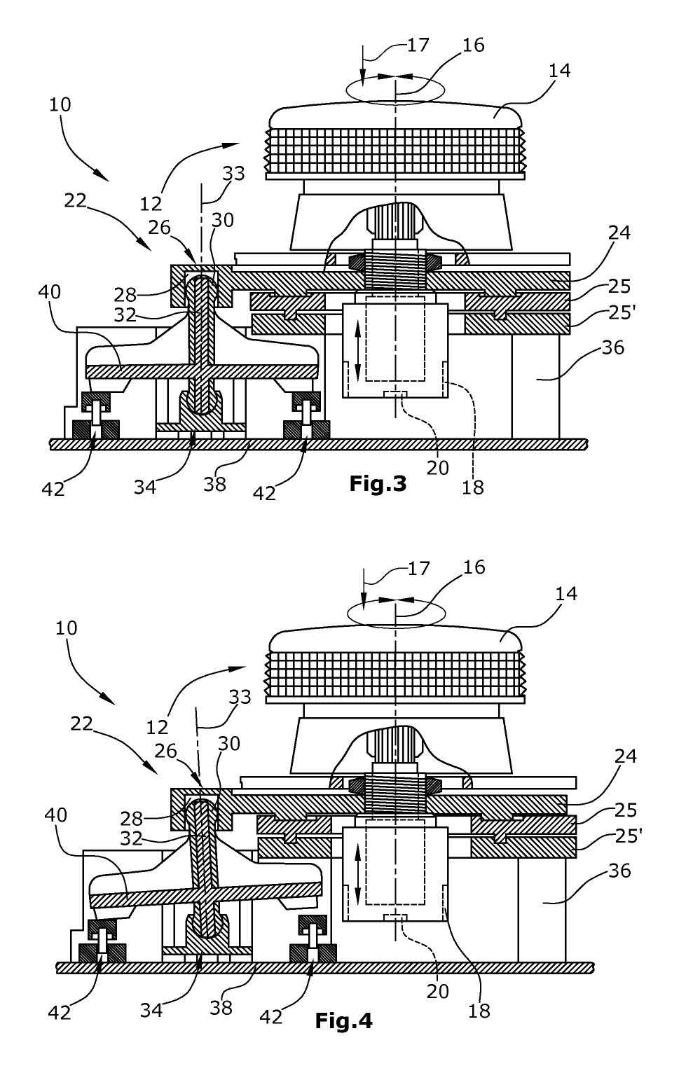

FIG. 3 a side elevational view of the operating device in the home position of the operating unit, and

FIG. 4 a side elevational view of the operating device with the operating unit displaced laterally in the drawing plane of FIG. 4.

FIG. 1 is a perspective illustration of an embodiment of the multifunction operating unit 10. The same comprises a manually operable operating unit 12 that includes a rotary/push element 14 in the form of a rotary knob. The rotary/push element 14 is rotatable about an axis of rotation 16 and is resiliently depressible along the axis of rotation 16 in the direction of the arrow 17. In FIG. 3, a rotary sensor 19 for sensing the current rotational position of the rotary/push element 14 is illustrated in the lower housing 18 of the rotary/push element 14. A depression of the rotary/push element 14 is detected by means of a push (depression) sensor 20 (e.g. in form of an end switch).

The operating unit 12 is basically a standard operating unit with rotary and depression functions. According to the invention, such an operating unit 12 is used to be able to detect a laterally directed pulling or displacement of the rotary/push element 14 in a simple manner. For this purpose, the multifunction operating device 10 comprises a displacement sensor unit 22 having a driver element 24 in the form of a plate with which the operating unit 12 or the housing accommodating the rotary sensor 18, or another housing part of the operating unit 12, is connected, preferably rigidly, in particular in a form-fitting manner. In this case, the rigid connection serves to make a lateral movement of the rotary/push element 14 cause a lateral displacement of the driver element 24. For this purpose, the plate-shaped driver element 24 is guided linearly on a first displacement bearing plate 25 which in turn is guided linearly on a second displacement bearing plate 25′, which is effected in both cases by means of webs indicated in FIGS. 1 and 2 and guided in grooves. The two linear guides extend at right angles with respect to each other and are provided with return springs, so that the rotary/push controller 14 automatically returns to its centric position shown in FIG. 1 after having been manually moved and released. This type of guide for the rotary/push controller 14 is known per se.

The driver element 24 further has a joint 26 arranged outside the operating unit 12 and comprises a socket 28 of a ball joint. This socket 28 receives the spherical head 30 of a tilting element 32 with a tilting axis 33. The tilting element 32 itself is also tiltably supported via a ball joint bearing 34, namely on a holding structure 36 supporting the operating unit 12, the structure being provided on a base plate 38 which may be a circuit board, for instance.

With reference to FIG. 2, the tilting element 32 of this embodiment comprises four arms 40 arranged in a cross-like shape, the ends of which are arranged at a distance from the base plate 38. Four sensor elements 42 are arranged between the ends and the base plate 38, which elements detect an approximation of the respective associated end of an arm 40 of the tilting element 32. This may be effected in a contactless manner or by means of mechanical contact.

As is obvious from FIGS. 3 and 4, a lateral displacement of the operating unit 12 is converted into a tilting movement of the tilting element 32 about the tilting axis 33 thereof. With reference to FIG. 2, it can be seen that a lateral displacement of the rotary/push element 14 in any of the eight different directions 44.1 to 44.8 is converted into positions of the tilting element 32 tilted in different directions in space. With respect to the eight tilting directions of the tilting element 32, the same is tilted in the direction of the arrows 46.1 to 46.8. In each of these tilting directions one of the sensor elements 42 or another pair of sensor elements 42 responds. By this information and in knowledge of the position of these sensor elements, it may be assessed, based on the sensor signals, in which direction 44.1 to 44.8 the rotary/push element 14 has been displaced laterally.

### LIST OF REFERENCE NUMERALS

10 multifunction operating device, operating device

12 operating unit

14 rotary/push element

16 axis of rotation

17 arrow

18 (sensor) housing of the rotary/push element

19 rotary sensor

20 push sensor

22 displacement sensor unit

24 driver element

25 first displacement bearing plate

25′ second displacement bearing plate

26 joint

28 socket

30 spherical head

32 tilting element

33 tilting axis

34 ball joint bearing

36 holding structure

38 base plate

40 arms

42 sensor element

44 directions

46 arrows

1. A multifunction operating device, particularly as an input device for monitor-controlled devices such as computers, information or entertainment technology devices, vehicle components or generally for a man-machine interface, comprising
a manually operable operating unit, which can be rotated about an axis of rotation, depressed along the axis of rotation in a resilient manner, and laterally displaced in a substantially radial direction with respect to the axis of rotation,
wherein the operating unit has a rotary sensor for sensing the current rotational position and a push sensor for sensing a depression movement, and
a displacement sensor unit for sensing the direction of a substantially radial movement of the operating unit during the lateral displacement of said unit,
wherein
the displacement sensor unit has a driver element which is displaceably guided in a radial plane and to which the operating unit is mechanically coupled and which can be displaced along during the displacement of the operating unit,
the displacement sensor unit has a tilting element, which is connected to the driver element in an articulated manner and which can be tilted when the driver element is displaced, and
the displacement sensor unit also has at least one sensor for sensing the tilted position of the tilting element during a lateral displacement of the operating unit.

2. The multifunction operating device of claim 1, wherein the tilting axis of the tilting element and/or the tilting element are arranged outside the axis of rotation of the operating unit the prolongation of the axis of rotation thereof, as well as laterally beside the operating unit.

3. The multifunction operating device of claim 1, wherein the tilting element is adapted to be moved in a wobbling manner as the operating unit is displaced laterally.

4. The multifunction operating device of claim 1, wherein the displacement sensor unit has two sensor elements that are arranged on axes extending under an angle of substantially 90° and detect their respective distance from the tilting element or a component of the tilting element or from the displacement sensor unit or at least one component of the displacement sensor unit.

5. The multifunction operating device of claim 1, wherein the displacement sensor unit comprises at least three, preferably four sensor elements arranged under substantially equal angles with respect to each other, the sensor elements serving to detect the distances of the tilting element or at least one component of the tilting element or from the displacement sensor unit or at least one component of the displacement sensor unit to the respective sensor elements.

6. The multifunction operating device of claim 1, wherein the at least one sensor or the at least one sensor element is configured as an end switch.

7. The multifunction operating device of claim 1, wherein the at least one sensor or the at least one sensor element works in a contactless manner and/or capacitively, magnetically, resistively or optically.

8. The multifunction operating device of claim 1, wherein the operating unit has an outer first operating element rotatable about the axis of rotation of the operating unit, and that the operating unit has an inner second operating element surrounded by the first operating element and adapted to be depressed.

9. The multifunction operating device of claim 8, wherein also the first operating element is depressible.

10. The multifunction operating element of claim 8, wherein either the first operating element or the second operating element is resiliently depressible, or that both operating elements can be resiliently depressed together.
